(19) United States
(12) Patent Application Publication
(10) Pub. No.: US 2011/0197429 A1
(43) Pub. Date: Aug. 18, 2011

(54) Method of Magnetically Driven Simultaneous Assembly

(76) Inventor: Nuggehalli Ravindra, Summit, NJ (US)

(21) Appl. No.: 12/705,985

(22) Filed: Feb. 16, 2010

(51) Int. Cl. H01S 4/00

(52) U.S. Cl. 29/592.1

(57) ABSTRACT

Magnetically Driven Simultaneous Assembly is a method for the integration of devices onto substrates. It is a non-statistical, fully controllable and deterministic, simultaneous method of assembly with error checking and handling that is capable of scalable, versatile, and high-yield integration. The method employs a combination of magnetic and gravitational forces (as well as a bonding agent) to assemble devices onto substrates. Devices, coated with a layer of a soft magnetic material, are moved from an initial to a final location by the action of an array of electromagnets above a template. Various devices of arbitrary geometries, with different physical properties and functionalities, are positioned simultaneously above specific desired locations and dropped onto a template under the action of gravity by locally weakening the applied magnetic field. Desired locations on the template correspond to sites on a substrate that contain recesses matching the specifics of the devices. When all desired devices are placed on top of the template, a substrate is brought into contact with that template and devices are transferred from the template to the substrate (for example, by pressing or by rolling). Devices are physically secured onto a substrate by a bonding agent (such as a layer of an adhesive or a hard magnetic material) applied inside of the recesses. Sensors monitor the accuracy of the placement of devices on a template and provide continuous, real-time feedback to an external control unit that automates the process of assembly. If devices are not situated properly on a template, then a specified technique is employed to correct such errors before the final process transfers the devices onto a substrate, thus assuring an accurate, 100% yield.

### BACKGROUND OF INVENTION

Current technology can produce a wide array of sensor and actuator devices made from different materials. The ability to integrate these devices into complete systems and products is valued by industry because of the potential range of applications. The standard tool kit of fabrication consists mainly of bulk and surface silicon micromachining, laser micromachining and other lithographic techniques. However, industrial trends indicate that future generations of MEMS, sensors, and actuators will be integrated with other electronic and optical components onto a substrate to yield powerful and complex systems. Therefore, the development of large-scale, heterogeneous, and parallel integration techniques to assemble MEMS, electrical and optical devices onto a single substrate is critically important for the realization of low cost, high density, and high performance systems.

As the market for low cost and high density integrated circuits increases, new assembly techniques must be developed. Methods must be found to enable the assembly of devices onto dissimilar substrates. To improve performance and reduce the cost of assembly, compound semiconductor devices must often be integrated monolithically in order to activate circuitry that is embedded within the substrate. A primary interest is the integration of devices with CMOS technology in order to increase the number of on-wafer functions and ultimately reduce the cost, size, and weight of systems. However, combining different materials comes with inherent difficulties. Chief among these are mismatches of lattice properties and thermal expansion coefficients. For example, there are very large variations of thermal expansion coefficients between silicon and III-V compounds used for optoelectronic devices.

Current integration strategies often rely on ‘pick and place’ serial assembly techniques. These techniques encounter immediate and insurmountable speed and cost constraints especially in applications that require the assembly of a large number of components with high precision. Also, surface forces must be carefully controlled in order to prevent the unwanted adhesion of devices with each other and the tools of the assembly process. Because of these limitations, new, low-cost, and parallel assembly techniques are being investigated and introduced to industry.

As the dimensions of micro-electrical, micro-optical and micromechanical devices and systems decrease, there is a need for techniques that simplify the effective parallel process of assembly. Several approaches have been proposed for such assembly. They include selective area growth, flip chip bonding, epitaxial lift off, electrostatic alignment, and fluidic self-assembly. However, all of these approaches come with drawbacks and other technological issues that limit their application.

Selective area growth has been investigated as a potential method; its limitation comes from lattice and thermal mismatches.

Another method is epitaxial lift off. An epitaxial layer is released from its growth substrate; the layer, which is typically supported by a polymer membrane, is then bonded onto a host substrate by van der Waals forces. The devices can be processed either before or after the transfer of the layer depending on the requirements of the process. The technique suffers from various disadvantages, including the handling of potentially extremely thin epitaxial layers, which can be difficult, and any pre-processed devices that need to be aligned onto existing circuitry, which is time consuming.

Yet another approach is wafer bonding that is used to transfer a primary layer onto a secondary wafer. The primary layer and secondary wafer are then bonded together and processed into discrete devices. The methods major drawback is thermal expansion coefficient mismatch when the layer and wafer are comprised of different materials.

A common approach to bulk parallel processing is to align devices without individual manipulation. Techniques that follow that paradigm are vector potential parts manipulation, DNA and electrophoresis-assisted assembly, and fluidic self-assembly.

Vector potential parts manipulation allows for the alignment of devices by using electrostatics to direct and place units.

The DNA and electrophoresis-assisted assembly uses two sets of a DNA-like polymer film. One film is formed onto the individual parts and another complimentary film is deposited in substrate recesses on the wafer where the parts are to be placed. The parts will only adhere into those locations with matching DNA patterns.

In the fluidic self-assembly approach, carefully etched devices are placed onto a substrate with matching recesses. Separate devices are aligned and placed in the substrate recesses without active individual manipulation. However, the method requires the devices to be formed with beveled edges, which is costly to achieve, and the process is statistical therefore does not yield 100% accurate assembly.

Other methods to assemble devices utilize magnetic fields. The Magnetically Assisted Statistical Assembly (MASA), which was created at the Massachusetts Institute of Technology (Cambridge, Mass.), uses magnetic layers deposited onto devices and into substrate recesses. These magnetic layers caused the devices, which are slurried over the substrate, to adhere in the substrate recesses. The Magnetic Field Assisted Assembly (MFAA), which was created at the New Jersey Institute of Technology (Newark, N.J.), uses an external magnetic field to position the devices in substrate recesses. A third method being pursued at the Institute of Microelectronics (Singapore) uses an array of permanent magnets, placed under a substrate, which then drives devices that have been coated with a magnetic layer into substrate recesses by vibration.

These techniques are not free of important and limiting issues. While MFAA is deterministic, MASA and the method that employs the array of permanent magnets are statistical and do not guarantee 100% yield. Additionally, the methods suffer issues with respect to frustration and cross-interference as devices compete to reach a substrate recesses and the actual placement of devices into substrate recesses (for example, devices may enter substrate recesses in various angles and orientations which may be impossible to correct without additional and costly assembly steps).

The objective of the present invention is to provide a method for the parallel (simultaneous) processing of various devices. The method is capable of both manipulating individual devices and processing a large number of devices simultaneously, deterministically, and non-statistically. The method eliminates the issues with frustration and competition between devices and recesses and offers the ability to correct errors thereby achieving 100% yield. It is a technique for assembly that does not place special geometric or material constraints upon the devices or the substrate recesses. The only special preparations required are a layer of magnetic material deposited on the surface of the devices and a bonding agent applied in the substrate recesses. Also, because it is a room-temperature process, materials with different lattice and thermodynamic properties can be integrated with out damaging the devices and substrates.

In addition to the ability to assemble devices, the proposed method can be used to manipulate the material properties of a substrate by assembling onto it components with passive functionality. For example, components that manage stress and strain and that alter electrical and optical properties in semiconductors. The proposed method can be used to form composite materials by assembling different layers of materials onto a substrate.

### DESCRIPTION OF DRAWINGS

FIGS. 1 and 2 are cross-sectional schematics that illustrate the principle parts, functions, and operations of the invention.

FIG. 1 illustrates the general approach of the assembly process of the invention.

FIG. 2 illustrates other key aspects of the invention's functionality.

FIG. 3 is a top-down view that illustrates the simultaneous processing aspect of the assembly process of the invention.

FIG. 4 is a cross-sectional schematic that illustrates the integration of the devices onto the substrate.

### DESCRIPTION OF PREFERRED EMBODIMENTS

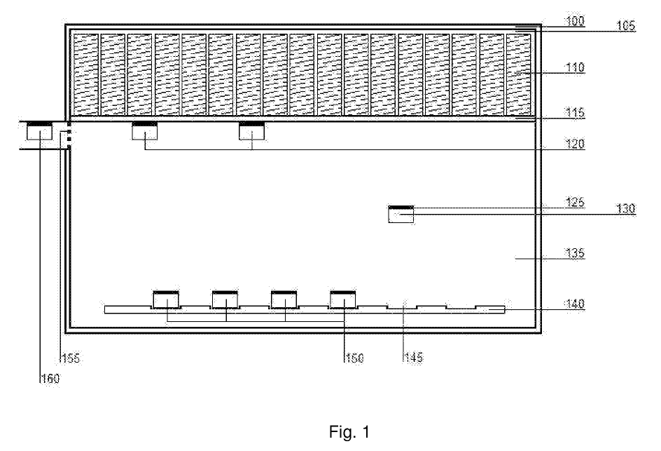

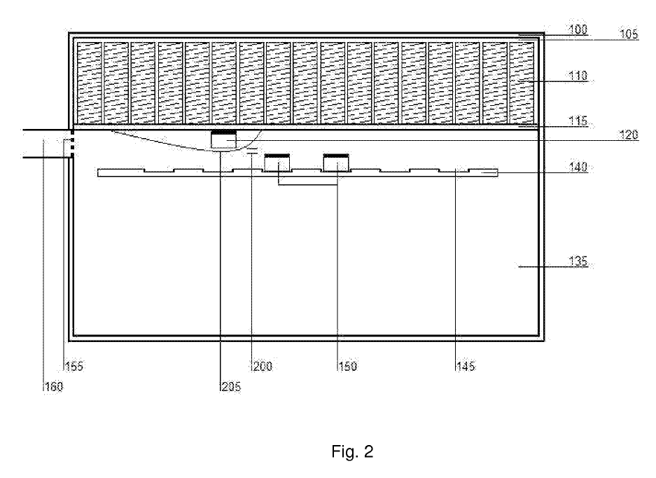

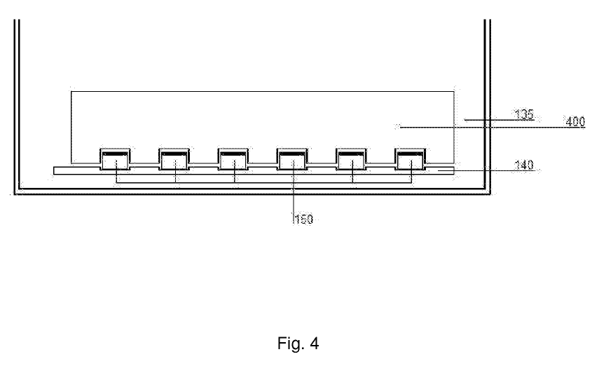

In reference to FIGS. 1 and 2 the process of assembly takes place within the enclosure 100. The enclosure 100 is divided by the shield 115 into two chambers. The lower chamber 135 is the assembly chamber 135 and the upper chamber 105 contains the array of electromagnets 110 that manipulates the positions of the devices 120. The lower assembly chamber 135 is to be kept at a high-quality vacuum. The upper chamber 105, with the array of electromagnets 110, is to be evacuated although it is not required to be a high-quality vacuum. The enclosure 100 is encircled by the injection ports 160, that are situated at intervals around its perimeter and through which devices 120 are introduced into the assembly chamber 135; it contains one or more templates 140 and substrates 400 (see FIG. 4). Although not depicted by the drawings, the enclosure 100 contains various electronic components, all of which are connected to an external control unit also not depicted by the drawings, such as: accuracy control sensors and mechanisms, pressure and temperature regulators, and other real-time sensing feedback equipment required to facilitate the process of assembly.

The upper chamber 105 of the enclosure 100 contains the array of electromagnets 110 along with a cooling mechanism, such as a heat sink or a heat bath, and various other leads connected to an external control unit that programs each and every electromagnet of the array 110. The array of electromagnets 110 produces localized magnetic fields (depicted by 205, see FIG. 2) that can be varied in magnitude, location, and time and that is used to manipulate the position of the devices 120 across the shield 115. To effect a fine control over the process of assembly the electromagnets of the array 110 are to be made as small as possible. Optionally, the electromagnets of the array 110 may be terminated in materials shaped into geometries that intensify and localize their magnetic field. Also, optionally, the electromagnets of the array 110 may contain internal auxiliary mechanisms that facilitate the disengagement of the devices 120 away from the shield 115; such mechanisms may protrude through the shield 115.

The shield 115 separates the upper 105 and lower 135 chambers of the enclosure 100. Its purpose is to protect the devices 120 from damage that may be caused by direct physical contact with the array of electromagnets 110 and to provide a smooth surface across which the devices 120 are moved by electromagnet array 110. Optionally, the shield 115 may be deformed either by mechanical or electromagnetic mechanisms to facilitate the process of assembly.

The enclosure 100 contains the assembly chamber 135 where the devices 120 are injected, positioned, and assembled.

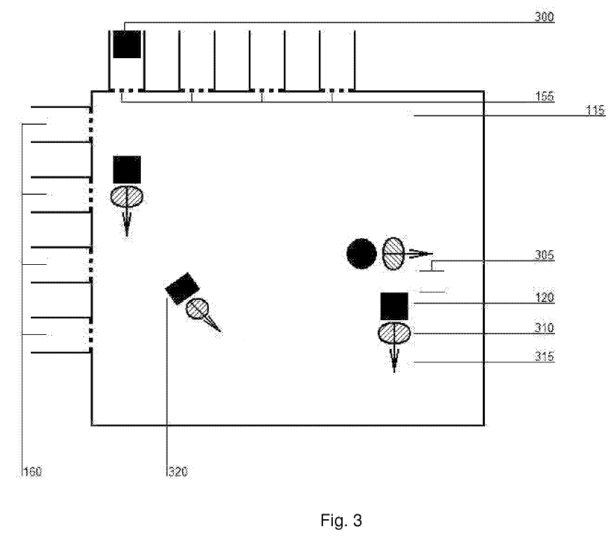

The top surface of the devices 120 is to be coated by a layer of soft magnetic material 125; the thickness of the layer 125 is to be such that it allows the devices 120 to be securely suspended against gravity by the force of magnetic attraction generated by the array of electromagnets 110. The action of the electromagnet array 110 causes the devices 120 to be held against the underside of the shield 115 and to be moved across that surface. Also, the devices 120 may be rotated into any required orientation by manipulating the field of the array of electromagnets 110 (depicted by 320, see FIG. 3).

The devices 120 are introduced into the assembly chamber 135 through the injection ports 160 and are suspended against the underside of the shield 115 by the force of magnetic attraction produced by the array of electromagnets 110. The electromagnet array 110 produces a localized magnetic field 205 that surrounds each device 120 on the shield surface. This field 205 is generated at certain rates, along certain paths, and draws the devices 120 from the injection ports 160 to desired locations immediately above matched recesses 145 on the template 140 (also 310, 315, see FIG. 3). The process of assembly simultaneously manipulates multiple devices 120 independently provided that the local magnetic field 205 are sufficiently short-range (with respect to the dimensions of the devices 120) and the devices 120 are separated beyond certain critical distances (where 200 from FIG. 2 is the minimum vertical distance and where 305 from FIG. 3 is the minimum lateral distance).

Once a device 120 is moved above its desired location 145 on the template 140, it is disengaged from the shield 115 by weakening the local magnetic field 205 below a certain threshold value. Each device 120 requires a minimum strength of the local magnetic field 205 to keep it suspended against the shield 115. If the local magnetic field 205 around the device 120 is weakened below that threshold, the device 120 falls from rest in the absence of an atmosphere under the action of gravity 130 from the shield 115 to the template 140 without deflection.

The template 140 is a magnetically passive construction upon which the devices 120 are temporarily placed in desired locations 145. The orientation of the template 140 can be altered, and the distance between the shield 115 and the template 140 can be varied (as depicted by FIG. 2). The template 140 can be a sheet of material, a strip of material and/or a series of materials attached to a mechanism that switches between different templates 140. A template 140 can be a single piece of material or it can be composed of interchangeable and/or interlocking parts. The desired locations 145 on the template 140 are to be aligned with the recesses of the substrate 400 on which the devices 120 will be integrated. Optionally, the template 140 may contain shallow recesses into which the devices 120 will be placed; these recesses may contain sensors that monitor the accurate placement of the devices 120.

The interface 155 between the injection ports 160 and the assembly chamber 135 is a partition that maintains the integrity of the vacuum within the enclosure 100.

Injection ports 160 around the perimeter of the enclosure 100 connect the assembly chamber 135 to bins (not depicted in the drawings) that contain the devices 300 prior to assembly (see FIG. 3). The injection ports 160 can be operated either mechanically or electromagnetically; they allow the devices 300 to be introduced into the assembly chamber 135 at a certain, controllable rate. Note that the bins may contain either one type of device or a known (and/or controllable) pattern of device types; note, also, that the bins are to be evacuated although the quality of the vacuum does not have to be high.

To complete the assembly process, the template 140 may be fully or partially populated by the devices 150 (see FIG. 4). In the case when the template is fully populated, then the final step of the process integrates all of the devices 150 onto the substrate 400 with one, single step. In the case when the template is partially populated, then the integration is accomplished through stages. Whether the assembly is accomplished by full or partial population, the integration step requires that the substrate 400 be placed in contact with the template 140, for example by pressing or by rolling. The devices 150 are physically secured into the recesses of the substrate 400 by a bonding agent (such as an adhesive or a layer of hard magnetic material) lining the bottom of the recesses.

If a device 120 is not placed in its desired location within a certain allowable tolerance, then an error-handling process is activated. The template 140 is raised up to the shield 115 and the array of electromagnets 110 activates above those devices 120 that were not properly placed. Once the devices 120 are reattached to the shield 115, they may be re-positioned until they are placed within tolerance. Also, devices 120 that were not properly placed may be omitted entirely from the integration step by a mechanical (or electrical) manipulation of the template 140 prior to the substrate 400 being put into contact with the template 140.

The process of assembly along with error-handling is automated by the external control unit. The rate at which the devices 120 are injected into the assembly chamber 135, the rate at which they are placed onto the template 140, the initial injection locations, the final desired positions, and the paths taken, along with such parameters as the device weights and dimensions, are aspects of the process that are monitored and manipulated by the external control unit. The simultaneous processing ability of the assembly and its high (100%) yield capability are achieved by controlling these parameters via real-time sensing and/or feedback.

1. A method for the assembly of devices onto a substrate comprising: Injection of devices into a chamber kept in a high-quality vacuum; The top surface of the device is coated with a layer of soft magnetic material that facilitates accurate positioning of the devices; A programmable array of electromagnets moves individual devices via simultaneous processing from the injection ports to the desired locations; the desired locations correspond to the sites of matched recesses on the substrate into which devices are to be integrated; The devices are moved by the action of the array of electromagnets, and then dropped onto the desired locations on the template by weakening the local magnetic field that suspends the devices; The devices, under the action of gravity in a vacuum, fall onto the template in the desired locations without deflection; If the devices do not land properly onto the desired locations, an error-handling mechanism is initiated; A substrate is placed in contact with the template (by pressing or by rolling); devices are then secured into the recesses of the substrate by the action of a bonding agent within the recesses.

2. A method in accordance with claim 1 that combines magnetic attraction and gravitational forces (and bonding action) to assemble devices onto a substrate.

3. A method in accordance with claim 1 that allows integration of various, heterogeneous types of devices via simultaneous (and/or sequential) processing and assembly; devices may be of a plurality of geometries, weights, and functionalities.

4. A method in accordance with claim 1 that allows integration of devices onto substrates by assembling those devices either fully or partially through stages.

5. A method in accordance with claim 1 that allows for the assembly of one or more substrates either fully or partially and that employs either one or more templates or portions of templates.

6. A method in accordance with claim 1 that allows the orientation and placement of the template to be varied continuously through the assembly process.

7. A method in accordance with claim 1 that allows for the changing of templates either continuously or at certain, controlled intervals during the assembly process.

8. A method in accordance with claim 1 that allows for the template(s) to be placed on a conveyor belt or any other conveying device.

9. A method in accordance with claim 1 that allows for the template(s) to be transferred out of the enclosure by a conveyor belt or any other conveying device for processing, error checking and/or handling, and/or assembly onto a substrate.

10. A method in accordance with claim 1 that allows an auxiliary mechanical or electrical mechanism to disengage devices from the shield.

11. A method in accordance with claim 1 that allows the surface of the shield to be deformed.

12. A method in accordance with claim 1 that includes sensors in the recesses of the template that monitor the accuracy of the assembly.

13. A method in accordance with claim 1 that allows the bins from which devices are injected into the assembly chamber to contain either a single type of device per bin or a known combination of devices per bin.

14. A method in accordance with claim 1 that allows the bin from which devices are injected to be either in a vacuum or not in a vacuum and with an injection port and interface that accommodates either condition and preserves the quality of the vacuum within the assembly chamber.

15. A method in accordance with claim 1 that can be scalable to accommodate the assembly of macroscopic, microscopic and nano-scale devices.

16. A method in accordance with claim 1 that achieves the maximum rate of assembly via simultaneous processing of devices by controlling the rates of device injection and placement, controlling the spacing between devices, and controlling the spatial extent of applied magnetic fields so that devices do not interfere with (i.e., impede the placement of) other devices.

17. A method in accordance with claim 1 that allows real-time sensing and feedback control of the assembly process.

18. A method in accordance with claim 1 that allows for the correction of errors to achieve 100% yield.
